(19) United States
(12) Patent Application Publication
(10) Pub. No.: US 2007/0094487 A1
(43) Pub. Date: Apr. 26, 2007

(54) Automatic resetting system and method

(75) Inventor: Chun Liang Lee, Taiwan (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/343,666

(22) Filed: Jan. 30, 2006

(30) Foreign Application Priority Data
Oct. 21, 2005 (TW) 94136840

(51) Int. Cl. G06F 15/177

(52) U.S. Cl. 713/1

(57) ABSTRACT

An automatic resetting system and method applied to an electronic device with a main BIOS program and a backup BIOS program implements a detecting module to detect whether a signal indicating proper system operation has been sent by the electronic device within a predetermined time. If not, then the detecting module generates a triggering signal to trigger a timing module to output a system restore signal, so that the electronic device is reset by executing the main BIOS program; meanwhile, the status value of the system restore signal is stored in a register module. If resetting by the main BIOS program fails, a controlling module of the automatic resetting system alters the status value stored in the register module so as to switch the electronic device from the main BIOS program to the backup BIOS program in order for the electronic device to reset by executing the backup BIOS program.

### FIELD OF THE INVENTION

The present invention relates to an automatic resetting technique, and more particularly, to an automatic resetting system and method applied in server system with a main BIOS program and a backup BIOS program to automatically switch to the backup BIOS program for resetting when the server system fails to reset using the main BIOS program.

### BACKGROUND OF THE INVENTION

Along with development of Internet and expansion of Intranet in companies, applications of network server systems increase. With the emergence of new job types and highly efficient working patterns, more specialized network server systems are in great demand, which has propelled the quality of the network server systems to a higher level. This, in terms of applications, implies enhancement in functionality and user-friendliness of the network server systems.

Although functions offered by current server systems have significantly improved, satisfying the needs of users at large, but often the users may not be specialized technical staff who understands fast-developing server systems well enough. Thus, there is an urgent need for developing server systems with vast functions that enable easy operations even by layperson. Especially, various malfunctions during operation of a server system are important issues to be addressed, for example when the server system cannot be started by writing into BIOS (Basic Input/Output System) in a ROM (Read Only Memory).

Current solution that addresses the problem of failure in starting the system by BIOS is to have dual BIOS programs, i.e. a main BIOS program and a backup BIOS program, respectively stored in two separate memories (e.g. Flash ROM). A jumper is disposed on a circuit board of the server system, such that if the main BIOS program is unable to start up the server system due to damage, the two memories are short-circuited via the jumper in order to allow the backup BIOS program to take over in restarting the server system. However, implementing in this manner requires a user to open the housing of the server system for physically joining the circuits of these two memories and press the power button to realize the restarting action, which is time and labor consuming and inefficient.

Due to the above shortcomings, in some high-level server systems, manufactures adds a microprocessor (e.g. 8031 microprocessor) or self-designed ASIC (Application-Specific Integrated Circuit) in order to monitor operating status of the server systems, so as to automatically restart the system when malfunctioning occurs. However, this type of design requires the provision of an additional microprocessor (or ASIC) and related circuits. Since designing and fabricating this microprocessor (or ASIC) increases the total cost, this approach is often only employed in high-level or higher pricing server systems. For low-level or less expensive server systems, manual operations in resetting the systems are still required.

Hence, there is a need for providing an automatic resetting system and method applicable in an electronic device with a main and a backup BIOS program, such that if the device cannot be started by the main BIOS, it is reset by the backup BIOS, eliminating the need for manual operation and providing a jumper or costly microprocessor (or ASIC) on the circuit board thereof.

### SUMMARY OF THE INVENTION

In the light of forgoing drawbacks, an objective of the present invention is to provide an automatic resetting system and method applicable in an electronic device for implementing automatic resetting of the electronic device.

Another objective of the present invention is to provide an automatic resetting system and method without manual interference that saves time and labor.

Still another objective of the present invention is to provide an automatic resetting system and method for enhancing efficiency of electronic device maintenance.

Yet another objective of the present invention is to provide an automatic resetting system and method that is suitable for all levels of electronic devices.

In accordance with the above and other objectives, the present invention provides an automatic resetting system and method applicable in an electronic device with a first storage unit and a second storage unit, which stores a main BIOS (Basic Input/Output System) program and a backup BIOS program, respectively. The automatic resetting system comprises: a detecting module for detecting if the electronic device has sent a system signal indicating proper operation of its system within a predetermined time, and generating a triggering signal when detecting that the electronic device has not sent the system signal within the predetermined time; a timing module for receiving the trigger signal generated by the detecting module and in response generating a system restore signal for allowing the electronic device to perform system automatic reset by executing the main BIOS program stored in the first storage unit; a register module for temporarily storing a status value of the system restore signal; and a controlling module for determining whether the electronic device has successfully reset based on the status value stored in the register module, and when determining that the electronic device fails to reset, altering the status value in the register module to switch the electronic device from the first storage unit to the second storage unit, allowing the electronic device to perform automatic system reset by executing the backup BIOS program in the second storage unit.

The above electronic device can be a computer system or a server system.

The automatic resetting system further comprises a reset signal generating module for generating a system reset signal in response to the system restore signal generated by the timing module, so that when the electronic device malfunctions, the electronic device allowed to perform automatic system reset by executing one of the main BIOS program in the first storage unit and the backup BIOS program in the second storage unit.

The automatic resetting method comprises the steps of:

(1) causing the automatic resetting system to detect if the electronic device has sent a system signal indicating proper operation of its system within a predetermined time, if so, proceed to step (5); else go to step (2);

(2) causing the automatic resetting system to generate a system restore signal, then proceed to step (3);

(3) causing the automatic resetting system to switch the electronic device from the first storage unit to the second storage unit, then proceed to step (4);

(4) causing the automatic resetting system to store a status value of the system restore signal and display the status value, then proceed to step (5);

(5) determining whether the automatic resetting system has altered the status value, if so, go to step (6), or else return to step (4); and

(6) causing the automatic resetting system to switch to the first storage unit so as to repair contents of the first storage unit and restore its functionality.

Hence, the automatic resetting system and method of the present invention applicable in an electronic device (e.g. a server system) with a main BIOS program and a backup BIOS program implements a detecting module to detect whether a signal indicating proper system operation has been sent by the electronic device within a predetermined time. If not, then the detecting module generates a triggering signal to trigger a timing module to output a system restore signal, so that the electronic device is reset by executing the main BIOS program; meanwhile, the status value of the system restore signal is stored in a register module. If resetting by the main BIOS program fails, a controlling module of the automatic resetting system alters the status value stored in the register module so as to switch the electronic device from the main BIOS program to the backup BIOS program in order for the electronic device to reset by executing the backup BIOS program. This avoids the need for manual operation and providing jumper on the circuit board of the electronic device that are time and labor consuming, as well as difficult for system maintenance.

The present invention thus achieves automatic switching of BIOS programs of electronic devices by simple circuit design and suitable software program. Thus, the expensive microprocessor (or ASIC) on the circuit board in the prior art can be avoided. Furthermore, the automatic resetting system and method are suitable for various levels of electronic products.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing the basic structure of the automatic resetting system of the present invention;

FIG. 2 is a circuit diagram of the automatic resetting system of the present invention; and

FIG. 3 is a flowchart of the automatic resetting method of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

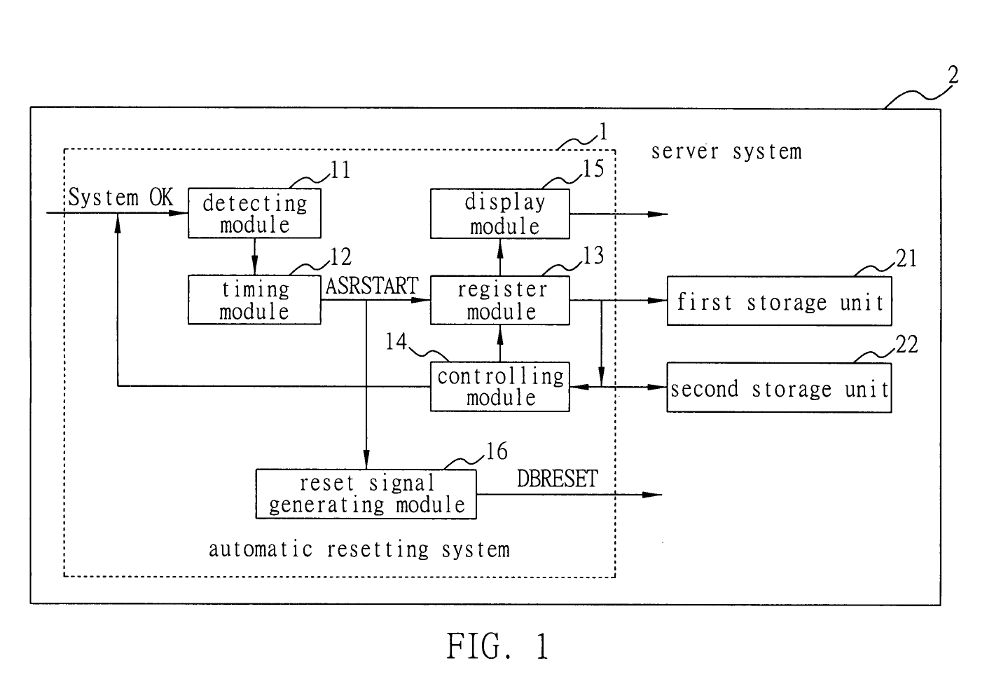

FIG. 1 is a schematic block diagram showing basic structure of an automatic resetting system of the present invention. As shown, the automatic resetting system 1 of the present invention is applied in an electronic device, which may be a computer system or a server system. In order to simplify descriptions and drawings, a server system is used for descriptions and illustration, but applications of the present invention is not limited to this. As shown in FIG. 1, the automatic system 1 is applied in a server system 2, which comprises a first storage unit 21 and a second storage unit 22, wherein the first storage unit 21 and the second storage unit 22 store a main BIOS program and a backup BIOS program, respectively.

As shown, the automatic resetting system 1 comprises a detecting module 11, a timing module 12, a register module 13, a controlling module 14, a display module 15 and a reset signal generating module 16.

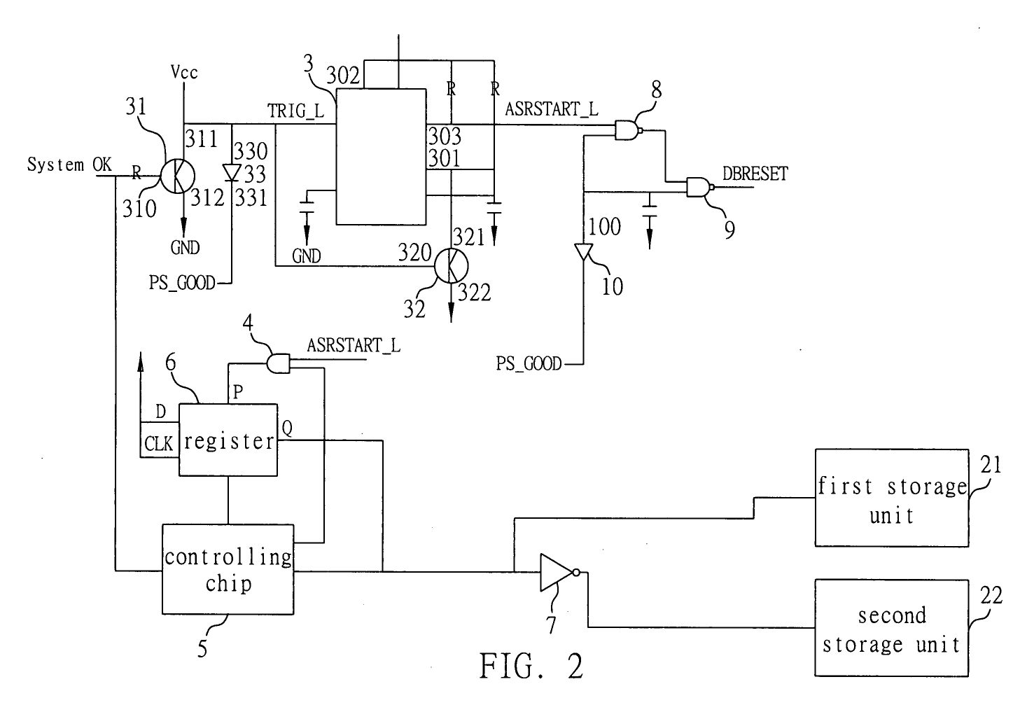

The detecting module 11 is connected to the server system 2 for detecting if the server system 2 has sent a system signal (system_OK) indicating normal operation thereof within a predetermined time. Specifically, if the server system 2 is operating smoothly, then the detecting module 11 generates a null signal to reset the timing of the timing module 12 to zero, so that the timing module 12 is not actuated and the normal operation of the system is ensured. When the server system 2 is not function properly, the server system 2 will not timely send out the system signal (system_OK), the detecting module 11 generates a triggering signal to actuate the timing module 12 to generate a system restore signal (ASRSTART). The above detecting module 11 can be a detecting circuit made of transistors and diodes (as later shown in FIG. 2). Moreover, the above predetermined time can be set by the user.

The timing module 12 is connected with the detecting module 11 for making corresponding actions upon receiving the detecting signals sent by the detecting module 11. Specifically, if the server system 2 is operating normally, the timing module 12 resets to zero upon receiving the clearing signal sent by the detecting module 11. If the server system 2 is malfunctioning, the timing module 12 generates a system restore signal (ASRSTART) based on the triggering signal sent by the detecting module 11. The above timing module 12 can be a timing circuit consisting of a timer and its peripheral elements and circuits (as later shown in FIG. 2).

The register module 13 is used for temporarily storing the status value (e.g. logic “0” or “1”) of the system restore signal generated by the timing module 12. In the present invention, the status value stored in the register module 13 is correlated with the first storage unit 21 and the second storage unit 22. For example, when the status value of the register module 13 is logic “0”, then the first storage unit 21 is enabled and connected to the server system 2. When the status value of the register module 13 is logic “1”, then the second storage unit 22 is enabled and connected to the server system 2. The above register module 13 is a register (as later shown in FIG. 2).

The controlling module 14, connected to the server system 2, is used for switching the server system 2 from the first storage unit 21 to the second storage unit 22 when the server system 2 malfunctions and the main BIOS program of the first storage unit 21 fails, so that the second storage unit 22 is electrically connected to the server system 2. Specifically, upon malfunctioning of the server system 2 due to failure of the main BIOS program of the first storage unit 21, the timing module 12 generates a system restore signal (ASRSTART) to change the status value in the register module 13 (e.g. change the status value of the register module 13 from “0” to “1”) in order to switch the server system 2 from the first storage unit 21 to the second storage unit 22, thereby allowing the server system 2 to operating the backup BIOS program of the second storage unit 22 for automatically resetting the system. When the server system 2 resumes back to normal operation, the server system 2 sends out the system signal (system_OK), and in turn the controlling module 14 generates the clearing signal (clear) to clear the status value of the system restore signal stored in the register module 13 and switch the connection of the server system 2 from the second storage unit 22 to the first storage unit 21 in order to repair the contents of the first storage unit 21 to restore its proper functioning. The above control module 14 is a control circuit consisting of electronic elements, such as an AND gate, a control chip, an inverter and the like (as later shown in FIG. 2).

Additionally, the automatic resetting system 1 of the present invention comprises the display module 15 for reading and outputting the status value of the register module 13 to display the read information on the server system 2, so that the user or controlling personnel can be informed of the current operating status of the server system 2. For example, when the server system 2 malfunctions, the status of the register module 13 is logic “0”. Thus, the system user or controlling personnel can be aware of the malfunctioning of the server system 2 by the signal outputted by the display module 15. Meanwhile, the first storage unit 21 is enabled by the status value “0” of the register module 13 for allowing the server system 2 to execute the main BIOS program in the first storage unit 21 to automatically reset the system. When the status value of the register module changes from logic “0” to logic “1”, the system user or controlling personnel can be aware of the malfunctioning of the server system 2 and that the system cannot be reset by the main BIOS program based on the signal outputted by the display module 15. That is, the main BIOS program of the first storage unit 21 is damaged; meanwhile, the second storage unit 22 is enabled by the status value “1” of the register module 13 for allowing the server system 2 to execute the backup BIOS program in the second storage unit 22 to automatically reset the system. Thereafter, when the server system 2 resumes its normal operation, the user or controlling personnel may then repair the main BIOS program in the first storage unit 21 or directly write over a new BIOS program into the first storage unit 21, so that when the server system 2 resets again in the future, the main BIOS program of the first storage unit 21 can automatically perform the reset procedure successfully. The above display module 15 is a software program.

Further, the automatic resetting system 1 of the present invention comprises the reset signal generating module 16 for generating a system reset signal (DBRESET) upon the timing module 12 generating the system restore signal, allowing the server system 2 to carry out the automatic system resetting process by executing the main BIOS program of the first storage unit 21 or the backup BIOS program in the second storage unit 22. The above reset signal generating module 16 is a reset signal generating circuit consisting of electronic elements such as a first NAND gate, a second NAND gate, a diode and the like.

FIG. 2 is a circuit equivalent diagram showing a specific circuit implementation of the automatic resetting system of the present invention. It should be noted that the drawing is simplified for illustrative purpose, showing only those elements related to the present invention. The actual number, types and arrangement of the circuit may be different from those shown, since they are a matter of design choices depending on various applications.

As shown in FIG. 2, the circuit structure of the automatic resetting system 1 of the present invention includes a timer 3 and its peripheral elements, such as a transistor 31, transistor 32, diode 33, AND gate 4, control chip 5, register 6, inverter 7 and related connection lines (not shown). Depending on actual implementation, these electronic elements such as the timer 3, transistor 31, transistor 32, diode 33, AND gate 4, control chip 5, register 6, inverter 7 can be replaced by other equivalent electronic elements and/or circuits.

As shown in FIG. 2, the base 310 of the transistor 31 is connected to the server system 2, the collector 311 thereof is connected to a voltage source Vcc (e.g. +5V) and a triggering pin 300 of the timer 3, respectively, and the emitter 312 thereof is grounded. The anode 330 of the diode 33 is connected to the collector 311 of the transistor 31 and the triggering pin 300 of the timer 3. The cathode 331 of the diode 33 is connected to the stable power supply PS_Good of the server system 2. The base 320 of the transistor 32 is connected to the collector 311 of the transistor 31 and the triggering pin 300 of the timer 3, the collector 321 of the transistor 32 is connected to a discharge pin 301 and a reset pin 302 of the timer 3, and the emitter 322 of the transistor 32 is grounded.

The two inputs of the AND gate 4 is respectively connected to the output pin 303 of the timer 3 and the controlling chip 5, the output thereof is connected to the register 6.

The controlling chip 5 is connected with the server system 2, the input of the AND gate 4 and the output of the register 6. In this embodiment, the controlling chip is a system input output/Southbridge (SIO/SB) chip. Depending on actual implementation, the SIO/SB chip can be replaced by other equivalent electronic elements and/or circuits.

The clock (CLK) and data (D) ports of the register 6 are both connected to a 5V voltage source Vcc. The output of the register 6 is connected to the first storage unit 21 and the controlling chip 5 and further connected to the second storage unit 22 via the inverter 7.

In order to illustrate the principles and effects of the present invention, the detailed working principles of the above circuit is discussed as follows.

When the server system 2 is not functioning properly, then the server system 2 no longer sends out the “system good” signal in predetermined time to the base 311 of the transistor 31. The collector 311 of the transistor 31 then generates a high-potential pulse signal (i.e. aforementioned triggering signal) to the trigger pin 300 of the timer 3, causing the timer 3 to generate a low-potential pulse signal ASRSTART (i.e. aforementioned system restore signal) through the output pin 303.

The low-potential ASRSTART signal and the high-potential signal generated by the controlling chip 5 are inputs of the AND gate 4, so as to store the status value of the low-potential pulse signal generated by the actuated timer 3 (e.g. logic “0”) in the register 6. The status value “0” of the register 6 would cause the first storage unit 21 to be enabled, thereby the server system 2 carrying out automatic system resetting by executing the main BIOS program of the first storage unit 21. After resetting, if the server system 2 sends out the high-potential pulse signal (indicating system working properly), i.e. aforementioned system_OK signal, in predetermined time, then the timer 3 is returned to zero to avoid system being reset. Meanwhile, upon receiving the system_OK signal, the controlling chip 5 determines the system is working properly, and thereby generates a low-potential clearing signal to the register to clear the information stored therein.

Otherwise, if after executing the main BIOS program of the first storage unit 21 for resetting the system, the server system 2 is still unable to send out the high potential pulse signal within predetermined time, the status value of the register 6 cannot be cleared in time, and by which the controlling chip 5 determines that the main BIOS program of the first storage unit 21 executed by the server system 2 failed to reset the system (i.e. the main BIOS program may be damaged), thereby generating a low-potential signal to the input of AND gate 4, which changes the output of the AND gate 4, and in turn changes the status value of the register 6, i.e. the status value of the register 6 changes from logic “0” to logic “1”. The selection between the first storage unit 21 and the second storage unit depends on the status value of the register 6. If the status value of the register 6 is logical “1”, then this high-potential logic “1” would disable the first storage unit 21, whereas the high-potential logic “1” is inverted to logic “0” after passing through the inverter 7, which enables the second storage unit 22. Thereby, the system changes from the first storage unit 21 to the second storage unit 22 to allow the server system 2 to execute the backup BIOS program of the second storage unit 22 for automatic system resetting. After the resetting, the server system 2 may send out the system_OK signal (i.e. high-potential pulse signal), the controlling chip then generates the clearing signal to clear the information stored in the register 6 upon receiving the system_OK signal. That is, the status value “1” stored in the registered is cleared, and the server system 2 changes from the second storage unit 22 to the first storage unit 21.

Additionally, the automatic resetting system 1 of the present invention can display the information stored in the register 6 via the above display module 15 to notify the user or controlling personnel to perform subsequent determination of current status of the system. When the server system 2 is not operating properly, appropriate measures can be taken based on the information displayed by the display module 15 so as to facilitate in maintenance of the system.

As mentioned, when the server system 2 resumes its normal operation, a system_OK signal (high-potential pulse signal) can be sent to the base 310 of the transistor 31 (e.g. a P-type transistor), so as to conduct the transistor 31 and generates a low-potential signal (i.e. a null signal) to the triggering pin 30 of the timer 3, such that the timing of the timer 3 is returned to zero. Meanwhile, the cathode 331 of the diode 33 is connected to the stable power supply PS_Good of the server system 2 to ensure that under normal operation of the server system 2 and normal power supply conditions, the triggering pin 300 of the timer 3 receives a low-potential signal at a predetermined interval, so that the timer 3 is not triggered for resetting.

As shown in FIG. 2, the circuit structure of the present invention further comprises a portion for generating a system reset signal DBRESET, which includes a first NAND gate 8, a second NAND gate 9 and a diode 10 in this embodiment. The output pin 303 of the timer and the anode 100 of the diode 10 are respectively connected to the two inputs of the NAND gate 8; the output of the NAND gate 8 and the anode 100 of the diode 10 are further respectively connected to two inputs of the NAND gate 9; the cathode 101 of the diode 10 is connected to the stable power supply PS_Good of the server system 2. Under normal power supply condition but server system 2 malfunctions, the low-potential pulse signal ASRSTART at the output pin 303 of the timer 3 results in a low-potential system reset signal DBRESET to be generated at the output of the second NAND gate 9, so as to allow the server system 10 to execute the main or backup BIOS program in the first storage unit 21 or the second storage unit 22 based on the system reset signal DBRESET. The above power inputs of the first NAND gate 8 and the second NAND gate 9 are both connected to the voltage source Vcc (e.g. 5V). Components such as resistors and capacitors can also be provided between the first NAND gate 8, the second NAND gate 9 and the diode 8. Depending on actual implementation, the NAND gate 8, the second NAND gate 9 and the diode 8 can be replaced by equivalent electronic elements and/or circuits.

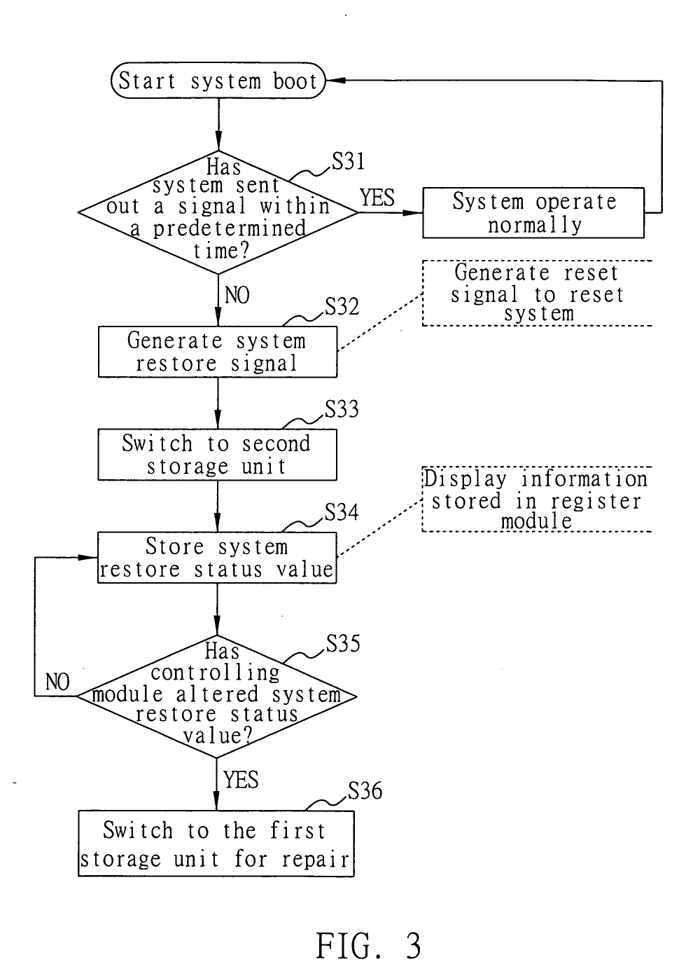

The automatic resetting method performed by the automatic resetting system of the present invention is illustrated in FIG. 3. The method comprises the following steps. In step S31, the detecting module 11 detects whether the server system 2 has sent out a system signal indicating normal operation within a predetermined time, if so, then the system operates properly, and the detecting module generates a null signal for resetting the timing of the timing module 12 to zero and the booting process performed by the first storage unit continues. If not, then continue to step S32.

In step S32, the detecting module 11 generates a triggering signal to trigger the timing module 12 in order to generate a system restore signal, which then causes the reset signal generating module 16 to generate a system reset signal. Thereafter, perform step S33.

In step S33, the controlling module 14 alters the status value of the system restore signal stored in the register module 13, such that the server system 2 is switched from the first storage unit 21 to the second storage unit 22. Then, go to step S34.

In step S34, the status value of the system restore signal stored in the register module 13 and displayed by the display module 15, and when the server system 2 resumes normal operation, the controlling module 14 clears the information stored in the register module 133. Continue to step S35.

In step S35, it is determined whether the controlling module has changed the status value in the register module 13, if so, go to step S36; if not, return to step S34.

In step S36, the server system 2 is switched back to the first storage unit 21 in order to repair the contents in the first storage unit 21 and restore its functionality.

Therefore, the automatic resetting system and method of the present invention, applied to an electronic device with a main BIOS program and a backup BIOS program, implements a detecting module to detect whether a signal, indicating that system is operating properly, has been sent by the electronic device within a predetermined time. If the detecting module is unable to detect the system signal sent by the electronic device, then the detecting module generates a triggering signal to trigger a timing module of the automatic resetting system to output a system restore signal, so that the electronic device can be reset by executing the main BIOS program; meanwhile, the status value of the system restore signal is stored in a register module. If resetting by the main BIOS program fails, a controlling module of the automatic resetting system alters the status value stored in the register module so as to switch the electronic device from the main BIOS program to the backup BIOS program. Thereupon, the electronic device can perform reset by executing the backup BIOS program, eliminating the need for manual operations and providing jumper in the circuit board that are both time and labor consuming and difficult for system maintenance.

The present invention achieves automatic switching of BIOS programs of electronic devices by simple circuit design and suitable software program. Thus, the expensive microprocessor (or ASIC) on the circuit board in the prior art can be avoided. Furthermore, the automatic resetting system and method are suitable for various levels of electronic products.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. An automatic resetting system applied in an electronic device with a first storage unit and a second storage unit, wherein the first storage unit and the second storage unit stores a main BIOS (Basic Input/Output System) program and a backup BIOS program, respectively, the system comprising:
a detecting module for detecting if the electronic device has sent a system signal indicating proper operation of its system within a predetermined time, and generating a triggering signal when detecting that the electronic device has not sent the system signal within the predetermined time;
a timing module for receiving the trigger signal generated by the detecting module and in response generating a system restore signal for allowing the electronic device to perform system automatic reset by executing the main BIOS program stored in the first storage unit;
a register module for temporarily storing a status value of the system restore signal; and
a controlling module for determining whether the electronic device has successfully reset based on the status value stored in the register module, and when determining that the electronic device fails to reset, altering the status value in the register module to switch the electronic device from the first storage unit to the second storage unit, allowing the electronic device to perform automatic system reset by executing the backup BIOS program in the second storage unit.

2. The automatic resetting system of claim 1, wherein when the electronic device resumes normal operation and that the detecting module detects the system signal sent by the electronic device within the predetermined time, the detecting module generates a null signal to reset the timing of the timing module back to null.

3. The automatic resetting system of claim 1, wherein the controlling module is a switching circuit comprising an AND gate, an inverter and a controlling chip.

4. The automatic resetting system of claim 3, wherein two inputs of the AND gate are connected to the timing module and the controlling chip.

5. The automatic resetting system of claim 3, wherein output of the AND gate is connected to the register module.

6. The automatic resetting system of claim 3, wherein the controlling chip is a System Input Output/Southbridge (SIO/SB) chip.

7. The automatic resetting system of claim 1, further comprising a display module for displaying the status value stored in the register module.

8. The automatic resetting system of claim 1, further comprising a reset signal generating module for generating a system reset signal in response to the system restore signal generated by the timing module, allowing the electronic device to perform automatic system reset by executing one of the main BIOS program in the first storage unit and the backup BIOS program in the second storage unit.

9. An automatic resetting method applied in an electronic device with a first storage unit and a second storage unit via an automatic resetting system, wherein the first storage unit and the second storage unit stores a main BIOS (Basic Input/Output System) program and a backup BIOS program, respectively, the method comprising:
(1) causing the automatic resetting system to detect if the electronic device has sent a system signal indicating proper operation of its system within a predetermined time, if so, proceed to step (5); else go to step (2);
(2) causing the automatic resetting system to generate a system restore signal, then proceed to step (3);
(3) causing the automatic resetting system to switch the electronic device from the first storage unit to the second storage unit, then proceed to step (4);
(4) causing the automatic resetting system to store a status value of the system restore signal and display the status value, then proceed to step (5);
(5) determining whether the automatic resetting system has altered the status value, if so, go to step (6), or else return to step (4); and
(6) causing the automatic resetting system to switch to the first storage unit so as to repair contents of the first storage unit and restore its functionality.

10. The automatic resetting method of claim 9, wherein the electronic device is a server system.
